(19) United States
(12) Patent Application Publication
(10) Pub. No.: US 2009/0081528 A1
(43) Pub. Date: Mar. 26, 2009

(54) SUPPORTED CATALYST FOR FUEL CELL, AND ELECTRODE AND FUEL CELL USING THE SAME

(76) Inventors: Yoshihiko Nakano, Yokohama-Shi (JP); Jun Tamura, Yokohama-Shi (JP); Mutsuki Yamazaki, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/207,851

(22) Filed: Sep. 10, 2008

(30) Foreign Application Priority Data
Sep. 21, 2007 (JP) 2007-245130

(51) Int. Cl. H01M 4/48; B01J 21/18

(52) U.S. Cl. 429/43; 502/182; 502/185; 429/44

(57) ABSTRACT

The present invention provides a supported catalyst excellent both in catalytic performance and in stability against concentrated methanol. The supported catalyst is used for an electrode of a fuel cell, and comprises catalytic metal particles supported on supports. The supports have hydrophilicity. On at least one part of the surface of the hydrophilic supports, particles of metal oxide super-strong acid are also supported. The metal oxide super-strong acid particles promote proton conduction.

### CROSS-REFERENCE TO RELATED APPLICATIONS

This application is based upon and claims the benefit of priority from the prior Japanese Patent Applications No. 245130/2007, filed on Sep. 21, 2007; the entire contents of which are incorporated herein by reference.

### BACKGROUND OF THE INVENTION

1. Field of the Invention

The present invention relates to a supported catalyst for a fuel cell, and in detail relates to a supported catalyst used in producing an electrode of a fuel cell. The invention also relates to an electrode of a fuel cell employing said supported catalyst.

2. Background Art

A fuel cell is a device in which fuel such as hydrogen or methanol is electrochemically oxidized to convert directly chemical energy of the fuel into electric energy. Unlike thermal power generation, the fuel cell provides electric energy without firing the fuel to generate NOₓ and SOₓ. That is, therefore, regarded as a clean and efficient source of electric energy, and hence has attracted the attention of people. In particular, since a polymer electrolyte fuel cell can be downsized and lightened, it has been vigorously studied to use as an electric power supply for a space ship and, nowadays, for an automobile.

As a structure of an electrode assembly installed in a conventional fuel cell, a five-layered sandwich structure of cathode current collector/cathode/proton-conductive membrane/anode/anode current collector is proposed, for example. In producing the electrodes, namely, cathode and anode, of the fuel cell, it is particularly important to protect the electrodes from poison such as carbon monoxide and to improve the activity per unit of catalyst. For the protection from poison and for the improvement of activity, it has been hitherto proposed to select a catalytic metal and to load the selected simple or alloy metal onto supports to prepare a supported catalyst. Thus, various catalysts for fuel cells have been developed, and electrodes using them have been practically employed.

In the supported catalyst for a fuel cell, carbon is generally adopted as the supports for supporting the catalytic metal. The reason of that is because carbon has electrical conductivity and hence it is thought that the catalytic metal should be directly supported on the carbon so that electrons generated on the surface of the catalytic metal can be effectively led out.

However, a carbon-supported catalyst, such as platinum or alloy thereof thickly supported on carbon supports, sometimes ignites when brought in contact with an organic solvent (particularly, alcohol), and therefore there is room for improvement in view of safety. Particularly in the case where a proton-conductive substance is used in producing an electrode, it is necessary to adopt a solvent containing alcohol in consideration of solubility and accordingly it is necessary to take some measures against the ignition when the above carbon-supported catalyst is added to prepare a slurry composition for forming the electrode. Generally, to avoid the ignition, water and the catalyst are mixed and stirred well so that the surface of the catalyst may be wetted, and then the solution of the proton-conductive substance is added to prepare the slurry.

However, the carbon-supported catalyst is generally so hydrophobic that particles of the catalyst are liable to aggregate when stirred together with water, and as a result the proton-conductive substance added thereafter is often difficult to disperse homogeneously all over the catalyst. Inevitably, a triple phase boundary, which is necessary for working of a fuel cell, is not formed in many particles, and consequently the resultant catalyst often has poor efficiency. Further, a polymer electrolyte, which is used as the above proton-conductive substance in a conventional electrode, is liable to dissolve in liquid fuel such as methanol, and hence there is another problem in view of durability.

### SUMMARY OF THE INVENTION

The present invention provides a supported catalyst for a fuel cell, comprising, on a carbon support, catalytic metal particles and particles of metal oxide super-strong acid which promote proton-conduction; wherein said particles of metal oxide super-strong acid are supported on said carbon support directly or via said catalytic metal particles.

The present invention also provides an electrode of a fuel cell, comprising a catalytic layer containing a nonionic binder and the above supported catalyst for a fuel cell.

The present invention further provides a fuel cell comprising the above electrode.

In the supported catalyst according to the present invention, the particles of metal oxide that promotes proton-conduction are supported on the supports together with the catalytic metal particles. The catalyst of the present invention, thereby, is excellent in catalytic performance and is very stable against concentrated methanol, and accordingly can improve reliability of a fuel cell using concentrated fuel.

### BRIEF DESCRIPTION OF THE DRAWINGS

FIG. 1 is a schematic cross-sectional view showing an essential structure of a fuel cell according to one embodiment of the present invention.

### DETAILED DESCRIPTION OF THE INVENTION

### [Supported Catalyst]

The supported catalyst according to the embodiment of the present invention comprises carbon supports, catalytic metal nanoparticles, and nanoparticles of metal oxide super-strong acid which promotes proton-conduction. The catalytic metal particles are supported on the carbon supports, and the nanoparticles of metal oxide super-strong acid are also supported on the carbon supports directly or via the catalytic metal particles. The particles of metal oxide super-strong acid have a mean particle size of 1 to 9 nm, and are supported in an amount of 0.5 to 40 wt. % per the weight of the supported catalyst. The average particle size is preferably 9 nm or less for keeping the catalytic activity at a high level, but is also preferably 1 nm or more in consideration of production cost and easiness in synthesizing the catalyst. The carbon supports may be nano-carbon supports in any form such as carbon nanoparticles or carbon nanofibers. The specific surface area of the carbon supports is preferably in the range of 10 to 2500 m²/g, more preferably in the range of 50 to 1000 m²/g. If it is smaller than 10 m²/g, the supports cannot support a sufficient amount of the particles. On the other hand, it is often difficult to synthesize the supports having a specific surface area larger than 2500 m²/g. In the embodiment of the present invention, the average particle size is calculated from the half-width of the peak obtained by the XRD measurement, and the specific surface area is measured by the BET method.

The catalytic metal used in the embodiment of the present invention is not particularly limited, and is selected from the generally known metals. However, the catalytic metal nanoparticles are preferably particles of platinum or an alloy of platinum with at least one element selected from the group of elements of the platinum group and transition elements of the 4th to 6th periods. The elements of the platinum group are, for example, Pt, Ru, Rh, Ir, Os, and Pd. Preferred examples of the catalytic metal include Pt, Pt—Ru, Pt—Ru—Ir, Pt—Ru—Ir—Os, Pt—Ir, Pt—Mo, Pt—Ru—Mo, Pt—Fe, Pt—Co, Pt—Ni, Pt—Ru—Ni, Pt—W, Pt—Ru—W, Pt—Sn, Pt—Ru—Sn, Pt—Ce, and Pt—Re. These examples, however, by no means restrict the invention.

The metal oxide super-strong acid used in the present invention promotes proton-conduction, and in other words has proton-conductivity. In a preferred embodiment of the present invention, the metal oxide super-strong acid is a composite substance composed of at least one oxide (hereinafter, often referred to as “oxide A”) selected from the group of titanium oxide TiOₓ (1≦x≦2), zirconium oxide ZrOₓ (1<x≦2) and tin oxide SnOₓ (1<x≦2), and another oxide (hereinafter, often referred to as “oxide B”) containing at least one element selected from the group of W, Mo, V and B. Examples of the metal oxide super-strong acid include TiO₂/WO₃, TiO₂/MoO₃, TiO₂/V₂O₅, TiO₂/B₂O₃, ZrO₂/WO₃, ZrO₂/MoO₃, ZrO₂/V₂O₅, ZrO₂/B₂O₃, SnO₂/WO₃, SnO₂/MoO₃, SnO₂/V₂O₅, and SnO₂/B₂O₃. These examples, however, by no means restrict the invention.

For promoting proton-conduction, the metal oxide super-strong acid is preferably a solid acid having a Hammett acidity function H₀ satisfying the condition of:

−20.00<H₀<−11.93.

The particles of metal oxide super-strong acid are supported in an amount of preferably 0.5 to 40 wt. %, more preferably 0.5 to 15 wt. % per the weight of the supported catalyst. If the amount is less than 0.5 wt. %, the proton-conduction is often insufficiently improved. On the other hand, if the amount is more than 40 wt. %, the resistance of the resultant electrode is liable to increase to lower the performance of the fuel cell.

In a conventional supported catalyst for a fuel cell, the catalytic activity depends upon the catalytic metal particles while the carbon supports generally serve both as supports (supports) of the catalytic metal particles and as electrically conductive paths. When the conventional supported catalyst is used for producing an electrode of a fuel cell, it is necessary to incorporate and disperse a proton-conductive substance. In the embodiment of the present invention, the hydrophilic metal oxide super-strong acid, which promotes proton-conduction, is incorporated into the conventional supported catalyst. Consequently, since both of the catalytic metal and the hydrophilic metal oxide super-strong acid are supported on the supports, the supported catalyst in itself naturally has proton-conductivity, electrical conductivity and catalytic activity for oxidation-reduction reactions.

The embodiment of the present invention can both prevent the ignition and improve dispersability of the catalyst, that is to say, can solve the aforementioned problems at the same time. As described above, in order to prevent the ignition caused by organic solvents, it is preferred to add water before preparing the slurry composition. However, in synthesizing the conventional catalyst comprising carbon supports, the carbon supports are too hydrophobic to disperse well. In contrast, the supported catalyst is improved in dispersability because the particles of hydrophilic metal oxide super-strong acid are supported on the supports. Further, in the embodiment of the present invention, since both of the catalytic metal and the proton-conductive substance are supported on the same supports, reaction interfaces can be effectively used to improve the catalytic performance in total.

The process for preparation of the supported catalyst according to the embodiment of the present invention is then described below.

First, the catalytic metal is loaded onto the carbon supports by the co-precipitation method, by the impregnated method or by the sputtering method. The carbon supports thus made to support the catalytic metal is then placed in a sputtering apparatus equipped with a stirrer. While the carbon supports are stirred, the metal oxide super-strong acid is loaded on the carbon supports under reduced pressure, for example, under about 100 Pa. In this procedure, the sputtering may be performed while the supports are heated or exposed to UV light. The metal oxide super-strong acid can be obtained by combining oxides A and oxides B. The oxides A and B may be combined beforehand to obtain a super-strong acid, which is then used in the sputtering procedure. However, the oxides A and B may be independently sputtered simultaneously or step-by-step. For example, the oxide A may alone sputtered before the oxide B. The sputtering procedure can be performed by means of a magnetron sputtering apparatus or an ion-beam sputtering apparatus, but these by no means restrict the present invention.

The present invention also provides an electrode of a fuel cell comprising the above supported catalyst, a membrane electrode assembly comprising said electrode, and a fuel cell comprising said membrane electrode assembly. The embodiments thereof are described below.

### [Electrode and Membrane Electrode Assembly for Fuel Cell]

The process for producing an electrode of a fuel cell is described below. For producing the electrode comprising the above supported catalyst, a binder is incorporated.

As the binder, nonionic polymers or inorganic polymers are used. Preferred examples of the binder include organic polymers such as PTFE, PFA and PVA, and inorganic polymers obtained by the sol-gel method. Nonionic binders are also preferred. The amount of the binder is generally in the range of 1 to 30 wt. % of the composition described below. If it is less than 1 wt. %, the catalyst is often bound so insufficiently that the electrode layer is hardly formed. On the other hand, if it is more than 30 wt. %, the resistance is liable to increase to lower the performance of the fuel cell.

The electrode of a fuel cell is generally produced according to the wet method or the dry method.

In the production process according to the wet method, it is necessary to prepare a slurry composition containing the aforementioned components. First, the catalyst and water are mixed and stirred well, and a binder solution (dispersion) and an organic solvent are added. The mixture is then stirred by a dispersing machine to obtain the slurry. The organic solvent is normally a single solvent or a mixture of two or more solvents. As the dispersing machine, generally used machines (such as ball mill, sand mill, beads mill, paint shaker, and nanomizer) can be used. In this way, the slurry composition, which is a dispersion of the components, can be obtained.

The dispersion (slurry composition) thus obtained can be coated with proper means on a current collector (carbon paper, carbon cloth) previously subjected to water-repelling treatment, and then dried to form an electrode. In that case, the slurry is preferably controlled to contain the solvent in such an amount that the solid content is in the range of 5 to 60 wt. %. If the solid content is less than 5 wt. %, the membrane of the coated slurry is liable to come off. On the other hand, if it is more than 60 wt. %, it is difficult to coat the slurry. The water-repelling treatment previously applied to the carbon paper or carbon cloth can be desirably controlled in the area where the slurry composition is to be coated.

The electrode can be also produced according to the suction filtration method described below. First, the above supported catalyst and an electrically conductive material are dispersed in a solvent, and the dispersion is sucked and filtered through a carbon paper or carbon cloth (which is to be a current collector) serving as a filter paper to form an accumulated layer of the catalyst and the electrically conductive material. The accumulated layer is dried, and then a binder solution (dispersion) is soaked therein by the vacuum impregnated method. The layer thus treated is then dried to obtain an electrode. In the drying procedure, the layer may be heated to enhance the bonding of the binder.

The electrode can be still also produced by the steps of: immersing a catalytic composition comprising the above components and a particular pore-forming agent in an acidic or alkaline aqueous solution, to dissolve the pore-forming agent; washing the composition with ion-exchanged water; and drying to obtain an electrode. In this process, if immersed in an alkaline solution to dissolve the pore-forming agent, the composition is washed first with an acid and then with ion-exchanged water. The composition thus treated is dried to obtain an electrode.

In the electrode layer described above, a proton-conductive polymer may be incorporated. The amount thereof is generally 50 wt. % or less per the weight of the electrode layer. If it is more than 50 wt. %, the catalytic layer must be thickened so that a necessary amount of the catalyst can be contained, and as a result the resistance often increases to lower the performance of the fuel cell. The proton-conductive substance may be added when the catalyst is dispersed in a solvent to prepare the slurry composition for coating, or otherwise the formed electrode may be immersed in a solution of the proton-conductive polymer and then dried. The proton-conductive polymer may be any polymer as long as it contains sulfonic acid groups and does not dissolve in fuel or water. Examples of the proton-conductive polymer include perfluorosulfonic acid polymers (e.g., Nafion [trademark], available from DuPont; FLEMION [trademark], available from Asahi Glass Co., Ltd.; Ashiplex [trademark], available from Asahi Kasei Corporation), sulfonated PEEK, sulfonated imide, and sulfonated PES. These examples, however, by no means restrict the present invention. In the case where the proton-conductive polymer is incorporated, the binder, particularly, the nonionic binder is normally contained in an amount of 1 to 40 wt. % per the weight of the composition. The proton-conductive polymer, which is conventionally indispensable, can be omitted in the present invention because the metal oxide super-strong acid particles are supported on the carbon supports having high proton-conductivity.

Electrodes obtained by various methods described above can be combined with a proton-conductive solid membrane to fabricate a membrane electrode assembly. For example, the proton-conductive membrane is inserted between the electrodes, and then hot-pressed by means of a roll-press machine. In that case, the catalytic metal of Pt—Ru, which has high durability against methanol and carbon monoxide, can be adopted to produce an anode while the catalytic metal of platinum can be used for a cathode, to form a membrane electrode assembly (hereinafter, often referred to as “MEA”).

In fabricating the above MEA, the hot-press procedure is preferably carried out under the conditions of: a temperature of 100 to 180° C., a pressure of 10 to 200 kg/cm², and a pressing time of 1 to 30 minutes. If the temperature, the pressure or the pressing time is too low, too small or too short (namely, lower than 100° C., less than 10 kg/cm², or shorter than 1 minute), respectively, the electrodes and the membrane are insufficiently combined and as a result the resistance often increases to lower the performance of the fuel cell. On the other hand, however, if the temperature, the pressure or the pressing time is too high, too large or too long, respectively, the membrane and the current collectors are deformed too much or decomposed, so that the fuel and the oxidant cannot be smoothly supplied and further the membrane may be destroyed to impair the performance of the fuel cell.

The above slurry composition can be coated directly on a proton-conductive membrane, or otherwise coated on a transferring membrane and dried to form a catalytic layer, which is then transferred onto a proton-conductive membrane. The catalytic layer can be thus provided on a proton-conductive membrane. In this way, an anode catalytic layer and a cathode catalytic layer can be provided on the top and bottom surfaces, respectively, of the proton-conductive membrane to form a composition (hereinafter, often referred to as CCM [catalyst coated membrane]). Further, cathode and anode current collectors can be placed on the cathode and anode sides of the CCM, respectively, and then hot-pressed and thereby combined to form a MEA. The conditions for this hot-press procedure are the same as those described above.

### [Fuel Cell]

As an embodiment of the fuel cell comprising the electrode or the membrane electrode assembly according to the present invention, a direct methanol fuel cell is described below with the attached drawing referred to.

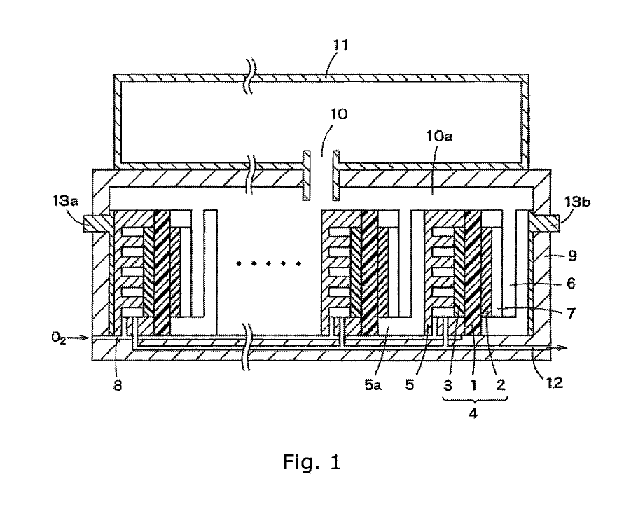

FIG. 1 is a schematic cross-sectional view showing an essential structure of a fuel cell according to one embodiment of the present invention. In FIG. 1, an electrolyte membrane 1 is sandwiched between a fuel electrode (anode) 2 and an oxidant electrode (cathode) 3, and an electromotive part 4 consists of the electrolyte membrane 1, the fuel electrode 2 and the oxidant electrode 3. The fuel electrode 2 and the oxidant electrode 3 are made of electrically conductive porous material which can conduct electrons and which fuel and oxidant gas can penetrate.

In the fuel cell according to this embodiment of the present invention, each unit cell comprises a fuel-osmosis part 6 and a fuel-vaporizing part 7. The fuel-osmosis part 6 retains the liquid fuel supplied from a fuel-storage tank 11, and the liquid fuel is vaporized and fed to the fuel electrode 2 through the fuel-vaporizing part 7. Plural unit cells, each of which comprises the fuel-osmosis part 6, the fuel-vaporizing part 7 and the electromotive part 4, are stacked via separators 5 to build a stack 9, which is the main body of the fuel cell. A continuous groove 8 for supplying the oxidant gas is provided on the surface of the separator 5 on the side facing the oxidant electrode 3. The gas after subjected the reaction is exhausted from a gas-outlet 12. The generated electric energy is led out from the terminals 13a and 13b.

For supplying the liquid fuel from the storage tank 11 to the impregnation part 6, a fuel-introducing path 10a may be provided along at least one side-wall of the stack 9. In that case, the liquid fuel is led into the fuel-introducing path 10a, and supplied to the impregnation part 6 from the side of the stack 9. The fuel is then vaporized in the vaporizing part 7, and is thereby fed to the fuel anode 2. If the impregnation part is made of material showing capillary phenomena, the liquid fuel can be supplied to the impregnation part 6 by the capillary force without any auxiliary means. For the purpose of that, however, it is necessary that the liquid fuel led into the path 10a be brought in direct contact with the end of the impregnation part.

In the case where the unit cells are combined to build a stack 9 as shown in FIG. 1, the separator 5, the impregnation part 6 and the vaporizing part 7 are made of electrically conductive materials since they also serve as current-collecting plates. Further, if necessary, catalytic layers in the form of films, islands or grains can be provided between the fuel electrode 2 and the electrolyte membrane 1 or between the oxidant electrode 3 and the electrolyte membrane 1. However, it by no means restricts the embodiment of the present invention whether these catalytic layers are provided or not. The fuel electrode 2 and the oxidant electrode 3 by themselves can serve as catalytic electrodes. The catalytic electrode may consist of the catalytic layer alone, but may have a multi-layered structure such as the catalytic layer formed on a support of electrically conductive paper or cloth.

As described above, the separator 5 in this embodiment also functions as a channel through which the oxidant gas flows. If a part 5a functioning both as the separator and as the channel (hereinafter, often referred to as “channel separator”) is adopted, the number of the parts can be decreased to downsize the fuel cell. It is also possible to use a normal channel instead of the above separator 5.

For supplying the liquid fuel from the storage tank 11 to the introducing path 10a, the fuel is made to free-fall from the tank 11 into the path 10a through the opening 10, for example. According to this supplying method, the liquid fuel can be surely led to the introducing path 10a although the storage tank 11 must be placed above the stack 9. In a different way, however, the liquid fuel may be sucked from the storage tank 11 by the capillary force of the introducing path 10a. In this supplying method, it is unnecessary to place the stack 9 below the junction between the tank 11 and the path 10a, namely, below the opening 10 of the path 10a. Accordingly, the above supplying methods may be appropriately combined so that the storage tank 11 can be freely placed.

In order that the fuel led into the path 10a by the capillary force can be further supplied smoothly to the impregnation part 6 by the capillary force, it is important that the capillary force for leading the fuel into the impregnation part 6 is set to be stronger than that of the path 10a. The number of the path 10a is not restricted to one, and another path 10a can be provided along the other side of the stack 9.

As described above, the fuel-storage tank 11 may be designed to be removal from the main body of the fuel cell. If having that structure, even when the fuel is exhausted, an empty tank can be replaced with a new one so that the fuel cell can work continuously for a long time. In order to supply the liquid fuel from the storage tank 11 to the introducing path 10a, the fuel may be made to free-fall as described above, or may be ejected by the inner pressure of the tank, or otherwise may be sucked by the capillary force of the introducing path 10a.

In the manner described above, the liquid fuel led into the introducing path 10a is supplied to the impregnation part 6. The impregnation part 6 may have any structure as long as it can retain the liquid fuel therein and can feed the fuel only in the form of vapor to the fuel electrode 2 through the fuel-vaporizing part 7. For example, the impregnation part 6 comprises a fuel channel and a gas-liquid separating membrane placed at the interface between the fuel channel and the vaporizing part 7. In the case where the liquid fuel is supplied to the impregnation part 6 by the capillary force, there is no particular restriction on the structure of the impregnation part 6 as long as the fuel can be soaked by the capillary force. For example, the impregnation part 6 may be a porous body comprising particles or fillers, may be made of non-woven fabric obtained by the papermaking process, or may be made of woven fabric. Further, the impregnation part 6 may comprise narrow chinks formed among glass or plastic plates.

With respect to the case where the impregnation part 6 is a porous body, the explanation is described below. The porous body naturally has the capillary force by which the liquid fuel is sucked into the impregnation part 6. For employing the capillary force effectively, porosities in the porous impregnation part 6 are preferably connected to form, what is called, “continuous porosities”, whose diameter is preferably controlled and which preferably lead from the sidewall facing the introducing path 10a to at least one of the other sidewalls of the part 6. If having those continuous porosities, the impregnation part 6 can supply the fuel even in the horizontal direction by the capillary force.

There is no particular restriction on the size of the porosities as long as the liquid fuel can be sucked from the introducing path 10a. In consideration of the capillary force of the path 10a, the average diameter is preferably in the range of 0.01 to 150 μm. The volume of the porosities, which indicates the degree of continuity of the porosities, is preferably in the range of 20 to 90%. If the average diameter is smaller than 0.01 μm, it is difficult to fabricate the impregnation part 6. On the other hand, if it is larger than 150 μm, the capillary force is often too weak. If the volume is less than 20%, the continuous porosities decrease and the closed porosities increase so that the capillary force is insufficiently obtained. In contrast, if the volume is more than 90%, the mechanical strength is lowered and hence it is often difficult to form the part 6 although the continuous porosities increase. From the practical viewpoint, the diameter and the volume of the porosities are preferably in the ranges of 0.5 to 100 μm and 30 to 75%, respectively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

### Example 1

### Preparation of Cathode Catalyst 1

In 1000 ml of water, 20 g of DENKA BLACK (FX-36 [trademark], available from Denki Kagaku Kogyo Kabushiki Kaisha; specific surface area: approximately 100 m²/g) was added and stirred with a homogenizer to prepare a suspension. The obtained suspension was placed in a three-neck flask equipped with a mechanical stirrer, a reflux condenser and a dropping funnel, and then stirred and refluxed for 1 hour. Thereafter, 160 ml of chloroplatinic acid aqueous solution (Pt: 42 mg/ml) was added, and the suspension was left for 20 minutes. Independently, 21.0 g of sodium hydrogencarbonate was dissolved in 600 ml of water, and the obtained solution was dropwise added to the suspension (time for dropping: approximately 60 minutes).

Successively, the mixture was refluxed for 2 hours, and then the precipitate was collected by filtration and washed with pure water. The obtained precipitate was transferred to another flask, and further refluxed in pure water for 2 hours. Thereafter, the precipitate was collected by filtration, washed with pure water, and dried in an oven at 100° C. to obtain catalyst material.

The catalyst material was placed in a highly-pure zirconia boat, and reduced in a cylindrical furnace at 200° C. for 10 hours while 3% H₂/N₂ gas was flowing in an amount of 129 ml. The reduced substance was cooled to room temperature to obtain 24.1 g of crude catalyst.

Thereafter, 10 g of the obtained crude catalyst was placed in an aluminum vessel, and set in a chamber of two-source magnetron sputtering apparatus equipped with a stirrer. The crude catalyst was confirmed to be stirred with the stirrer, and then the inner pressure of the chamber was gradually decreased. After the pressure reached a predetermined value, TiO₂ was sputtered for 4 hours by using RF power supply (13.56 Hz, 200 W) with the crude catalyst stirred while Ar gas was flowing in the chamber, and successively WO₃ was further sputtered for 1 hour by using RF power supply (13.56 Hz, 200 W). Thus, 12.4 g of supported catalyst (cathode catalyst 1) comprising a super-strong acid was obtained. The particles of the super-strong acid supported in the catalyst had a mean particle size of approximately 3.5 nm.

### Example 2

### Preparation of Cathode Catalyst 2

In 1000 ml of water, 20 g of DENKA BLACK (FX-36 [trademark], available from Denki Kagaku Kogyo Kabushiki Kaisha; specific surface area: approximately 100 m²/g) was added and stirred with a homogenizer to prepare a suspension. The obtained suspension was placed in a three-neck flask equipped with a mechanical stirrer, a reflux condenser and a dropping funnel, and then stirred and refluxed for 1 hour. Thereafter, 160 ml of chloroplatinic acid aqueous solution (Pt: 42 mg/ml) was added, and the suspension was left for 20 minutes. Independently, 21.0 g of sodium hydrogencarbonate was dissolved in 600 ml of water, and the obtained solution was dropwise added to the suspension (time for dropping: approximately 60 minutes).

Successively, the mixture was refluxed for 2 hours, and then the precipitate was collected by filtration and washed with pure water. The obtained precipitate was transferred to another flask, and further refluxed in pure water for 2 hours. Thereafter, the precipitate was collected by filtration, washed with pure water, and dried in an oven at 100° C. to obtain catalyst material.

The catalyst material was placed in a highly-pure zirconia boat, and reduced in a cylindrical furnace at 200° C. for 10 hours while 3% H₂/N₂ gas was flowing in an amount of 129 ml. The reduced substance was cooled to room temperature to obtain 24.1 g of crude catalyst.

Thereafter, 10 g of the obtained crude catalyst was placed in an aluminum vessel, and set in a chamber of two-source magnetron sputtering apparatus equipped with a stirrer. The crude catalyst was confirmed to be stirred with the stirrer, and then the inner pressure of the chamber was gradually decreased. After the pressure reached at a predetermined value, ZrO₂ was sputtered for 4 hours by using RF power supply (13.56 Hz, 200 W) with the crude catalyst stirred while Ar gas was flowing in the chamber, and successively WO₃ was further sputtered for 1 hour by using RF power supply (13.56 Hz, 200 W). Thus, 11.9 g of supported catalyst (cathode catalyst 2) comprising a super-strong acid was obtained. The particles of the super-strong acid supported in the catalyst had a mean particle size of approximately 3 nm.

### Comparative Example 1

In 1000 ml of water, 20 g of DENKA BLACK (FX-36 [trademark], available from Denki Kagaku Kogyo Kabushiki Kaisha; specific surface area: approximately 100 m²/g) was added and stirred with a homogenizer to prepare a suspension. The obtained suspension was placed in a three-neck flask equipped with a mechanical stirrer, a reflux condenser and a dropping funnel, and then stirred and refluxed for 1 hour. Thereafter, 160 ml of chloroplatinic acid aqueous solution (Pt: 42 mg/ml) was added, and the suspension was left for 20 minutes. Independently, 21.0 g of sodium hydrogencarbonate was dissolved in 600 ml of water, and the obtained solution was dropwise added to the suspension (time for dropping: approximately 60 minutes).

The mixture was successively refluxed for 2 hours, and then the precipitate was collected by filtration and washed with pure water. The obtained precipitate was transferred to another flask, and further refluxed in pure water for 2 hours. Thereafter, the precipitate was collected by filtration, washed with pure water, and dried in an oven at 100° C. to prepare catalyst material.

The catalyst material was placed in a highly-pure zirconia boat, and reduced in a cylindrical furnace at 200° C. for 10 hours while 3% H₂/N₂ gas was flowing in an amount of 129 ml. The reduced substance was cooled to room temperature to obtain 24.1 g of comparative catalyst.

### Comparative Example 2

### Preparation of Supported Anode Catalyst

The procedure of Comparative Example 1 was repeated, except that 160 ml of chloroplatinic acid aqueous solution was replaced with 80 ml of chloroplatinic acid aqueous solution and 40 ml of ruthenium chloride acid aqueous solution (Ru: 43 mg/ml), to obtain comparative supported anode catalyst.

### Example 3

### Preparation of Supported Anode Catalyst 1

The procedure of Example 1 was repeated, except that 160 ml of chloroplatinic acid aqueous solution was replaced with 80 ml of chloroplatinic acid aqueous solution and 40 ml of ruthenium chloride acid aqueous solution (Ru: 43 mg/ml), to obtain supported anode catalyst 1.

### Example 4

### Preparation of Supported Anode Catalyst 2

The procedure of Example 2 was repeated, except that 160 ml of chloroplatinic acid aqueous solution was replaced with 80 ml of chloroplatinic acid aqueous solution and 40 ml of ruthenium chloride acid aqueous solution (Ru: 43 mg/ml), to obtain supported anode catalyst 2.

### Example 5

In a 50 ml plastic vessel, 2.5 g of the cathode catalyst 1 obtained in Example 1, 5 g of pure water, 25 g of small zirconia beads (diameter: 5 mm), and 50 g of large zirconia beads (diameter: 10 mm) were mixed and stirred well. Further, 0.1 g of FEP dispersion (FEP 120J [trademark], available from Mitsui-DuPont Fluorochemical Co., Ltd.) and 5 g of 2-butoxyethanol were added and then dispersed for 2 hours by means of a paint shaker to obtain a slurry composition. The obtained composition was coated by means of a control coater (gap: 750 μm) onto a carbon paper (270 μm, available from Toray Industries, Inc.) previously subjected to water-repelling treatment, air-dried, and then dried at 60° C. for 30 minutes and further at 250° C. for 60 minutes, to produce a cathode 1. The catalytic layer had a thickness of 40 μm.

### Example 6

The procedure of Example 5 was repeated, except that the FEP dispersion was replaced with 5% PVA aqueous solution and ethanol was used as an organic solvent, to produce a cathode 2. The catalytic layer had a thickness of 35 μm.

### Example 7

In a 50 ml plastic vessel, 2 g of the anode catalyst 1 obtained in Example 3, 5 g of pure water, 25 g of small zirconia beads (diameter: 5 mm), and 50 g of large zirconia beads (diameter: 10 mm) were mixed and stirred well. Further, 0.1 g of FEP dispersion (FEP 1203 [trademark], available from Mitsui-DuPont Fluorochemical Co., Ltd.) and 5 g of 2-butoxyethanol were added and stirred well, and then dispersed for 2 hours by means of a paint shaker to obtain a slurry composition. The obtained composition was coated by means of a control coater (gap: 900 μm) onto a carbon paper (350 μm, available from Toray Industries, Inc.) previously subjected to water-repelling treatment, air-dried, and then dried at 60° C. for 30 minutes and further at 250° C. for 60 minutes, to produce an anode 1. The catalytic layer had a thickness of 38 μm.

### Example 8

The procedure of Example 7 was repeated, except that the FEP dispersion was replaced with 5% PVA aqueous solution and ethanol was used as an organic solvent, to produce an anode 2. The catalytic layer had a thickness of 43 μm.

### Comparative Example 3

In a 50 ml plastic vessel, 1.5 g of the cathode catalyst 1 obtained in Example 1, 3 g of pure water, 25 g of small zirconia beads (diameter: 5 mm), and 50 g of large zirconia beads (diameter: 10 mm) were mixed and stirred well. Further, 4.5 g of 20% Nafion solution and 5 g of 2-ethoxyethanol were added and stirred well, and then dispersed for 6 hours by means of a bench ball-mill to obtain a slurry composition. The obtained composition was coated by means of a control coater (gap: 750 μm) onto a carbon paper (270 μm, available from Toray Industries, Inc.) previously subjected to water-repelling treatment, and then air-dried to produce a cathode R1. The catalytic layer had a thickness of 80 μm.

### Comparative Example 4

The procedure of Comparative Example 3 was repeated, except that the anode catalyst obtained in Comparative Example 2 was used and the slurry composition was coated by means of a control coater (gap: 900 μm) onto a carbon paper (350 μm, available from Toray Industries, Inc.) previously subjected to water-repelling treatment, to produce an anode R1. The catalytic layer had a thickness of 100 μm.

### Example 9

The procedure of Example 5 was repeated, except that the cathode catalyst 2 obtained in Example 2 was used, to produce a cathode 3.

### Example 10

The procedure of Example 8 was repeated, except that the anode catalyst 2 obtained in Example 4 was used, to produce an anode 3.

### Example 11

It was examined whether the electrodes obtained above were dissolved or not in concentrated methanol fuel.

The electrodes produced in Examples 5 to 10 and Comparative Examples 3 and 4 were individually immersed in 95% methanol at room temperature, and observed whether they were dissolved or not. The results were as set forth in Table 1, which revealed that the electrodes according to the present invention were very stable even in concentrated methanol.

TABLE 1
Results of electrode-dissolving test

| Electrode | Dissolving test in 99.5% methanol |
|---|---|
| Cathode 1 | Not dissolved |
| Cathode 2 | Not dissolved |
| Cathode 3 | Not dissolved |
| Anode 1 | Not dissolved |
| Anode 2 | Not dissolved |
| Anode 3 | Not dissolved |
| Cathode R1 | Catalytic layer was complely dissoved |
| | (or redispersed) in approx. 5 minutes |
| Anode R1 | Catalytic layer was complely dissoved |
| | (or redispersed) in approx. 5 minutes |

### Example 12

The cathodes obtained in Examples 5, 6, 9 and Comparative Example 3 and the anodes obtained in Examples 7, 8, 10 and Comparative Example 4 were combined to fabricate some membrane electrode assemblies.

Each electrode was cut into a rectangular piece of 3×4 cm so that the electrode area might be 12 cm². As a proton-conductive solid polymer membrane, a membrane of Nafion 117 ([trademark], available from DuPont Co., Ltd.) was adopted. The Nafion 117 membrane was inserted between the anode and the cathode, and then hot-pressed at 125° C., 100 kg/cm² for 30 minutes to fabricate a membrane electrode assembly.

Independently, a carbon paper previously subjected to water-repelling treatment, the cathode in the form of a sheet obtained in Example 9, a Nafion 117 ([trademark], available from DuPont Co., Ltd.) membrane, the anode in the form of a sheet obtained in Example 10, and another carbon paper previously subjected to water-repelling treatment were laminated in order, and then hot-pressed at 125° C., 100 kg/cm² for 30 minutes to fabricate another membrane electrode assembly.

The fabricated MEAs were evaluated with respect to the performance of the fuel cell under the conditions that 1M methanol as a fuel was fed to the anode in the amount of 0.8 ml/minute and that air in the amount of 120 ml/minute was supplied to the cathode. The results were as set forth in Table 2, which revealed that the electrodes produced from the catalysts having proton-conductivity of the super-strong acids exhibited almost the same performance as those employing the conventional proton-conductive substance such as Nafion 117 ([trademark], available from DuPont Co., Ltd.).

TABLE 2
Results of cell-performance test at 70° C.

| Cathode | Anode | Voltage at current density 100 mA/cm² |
|---|---|---|
| 1 | R1 | 0.47 V |
| 2 | R1 | 0.48 V |
| 3 | R1 | 0.49 V |
| R1 | 1 | 0.48 V |
| R1 | 2 | 0.47 V |
| R1 | 3 | 0.48 V |
| 2 | 4 | 0.465 V |
| 3 | 3 | 0.47 V |
| R1 | R1 | 0.49 V |

1. A supported catalyst for a fuel cell, comprising, on a carbon support, catalytic metal particles and particles of metal oxide super-strong acid which promote proton conduction; wherein said particles of metal oxide super-strong acid are supported on said carbon support directly or via said catalytic metal particles.

2. The supported catalyst according to claim 1, wherein said particles of metal oxide super-strong acid have a mean particle size of 1 to 9 nm, and are supported in an amount of 0.5 to 40 wt. % per the weight of the supported catalyst.

3. The supported catalyst according to claim 1, wherein said metal oxide super-strong acid is a composite substance composed of at least one oxide selected from the group of titanium oxide TiOₓ (1<x≦2) zirconium oxide ZrOₓ (1<x≦2)and tin oxide SnOₓ (1<x≦2), and another oxide containing at least one element selected from the group of W, Mo, V and B.

4. The supported catalyst according to claim 1, wherein said catalytic metal particles are particles of platinum or an alloy of platinum with at least one element selected from the group of elements of the platinum group and transition elements of the 4th to 6th periods.

5. The supported catalyst according to claim 1, wherein said particles of metal oxide super-strong acid have a Hammett acidity function H₀ satisfying the condition of:
−20.00<H₀<−11.93.

6. An electrode of a fuel cell, comprising a catalytic layer containing a nonionic binder and a supported catalyst comprising, on a carbon support, catalytic metal particles and particles of metal oxide super-strong acid which promote proton conduction; wherein said particles of metal oxide super-strong acid are supported on said carbon support directly or via said catalytic metal particles.

7. The electrode according to claim 6, wherein said catalytic layer further contains a proton-conductive polymer.

8. The electrode according to claim 6, wherein said particles of metal oxide super-strong acid have a mean particle size of 1 to 9 nm, and are supported in an amount of 0.5 to 40 wt. % per the weight of the supported catalyst

9. The electrode according to claim 6, wherein said metal oxide super-strong acid is a composite substance composed of at least one oxide selected from the group of titanium oxide TiOₓ (1<x≦2) zirconium oxide ZrOₓ (1<x≦2)and tin oxide SnOₓ (1<x≦2), and another oxide containing at least one element selected from the group of W, Mo, V and B.

10. The electrode according to claim 6, wherein said catalytic metal particles are particles of platinum or an alloy of platinum with at least one element selected from the group of elements of the platinum group and transition elements of the 4th to 6th periods.

11. The electrode according to claim 6, wherein said particles of metal oxide super-strong acid have a Hammett acidity function H₀ satisfying the condition of:
−20.00<H₀<−11.93.

12. A fuel cell comprising an electrode, comprising a catalytic layer containing a nonionic binder and a supported catalyst, the supported catalyst comprising, on a carbon support, catalytic metal particles and particles of metal oxide super-strong acid which promote proton conduction; wherein said particles of metal oxide super-strong acid are supported on said carbon support directly or via said catalytic metal particles.

13. The fuel cell according to claim 12, wherein said catalytic layer further contains a proton-conductive polymer.

14. The fuel cell according to claim 12, wherein said particles of metal oxide super-strong acid have a mean particle size of 1 to 9 nm, and are supported in an amount of 0.5 to 40 wt. % per the weight of the supported catalyst.

15. The fuel cell according to claim 12, wherein said metal oxide super-strong acid is a composite substance composed of at least one oxide selected from the group of titanium oxide TiOₓ (1<x≦2) zirconium oxide ZrOₓ (1<x≦2)and tin oxide SnOₓ (1<x≦2), and another oxide containing at least one element selected from the group of W, Mo, V and B.

16. The fuel cell according to claim 12, wherein said catalytic metal particles are particles of platinum or an alloy of platinum with at least one element selected from the group of elements of the platinum group and transition elements of the 4th to 6th periods.

17. The fuel cell according to claim 12, wherein said particles of metal oxide super-strong acid have a Hammett acidity function H₀ satisfying the condition of:
−20.00<H₀<−11.93.
